(19) United States
(12) Patent Application Publication
(10) Pub. No.: US 2011/0012999 A1
(43) Pub. Date: Jan. 20, 2011

(54) METHOD AND INSTALLATION FOR OBTAINING AN IMAGE OF A SAMPLE EMITTING A LIGHT SIGNAL FROM WITHIN ITS INSIDE

(75) Inventors: Mickael Savinaud, Paris (FR); Nikos Paragios, Vincennes (FR); Serge Maitrejean, Paris (FR)

Correspondence Address: Osler, Hoskin & Harcourt LLP (Plasseraud), 1000 de la Gauchetiere Street West, Suite 2100, Montreal, QC, H3B 4W5, CA

(73) Assignee: BIOSPACE LAB, Paris (FR)

(21) Appl. No.: 12/922,350

(22) PCT Filed: Mar. 13, 2008
(86) PCT No.: PCT/IB08/52202

§ 371 Date: Sep. 13, 2010

(51) Int. Cl. H04N 13/02; H04N 7/18

(52) U.S. Cl. 348/50; 348/61; 348/E07.085; 348/E13.074

(57) ABSTRACT

A method for obtaining an image of a sample having an external surface enclosing an inside, a light signal being emitted from within the inside, the method comprising: (a) providing two positioning images each comprising the external surface of the sample, (b) providing a light-emission image comprising data related to the light signal emitted from within the inside of the sample, (c) detecting a landmark pattern integral with the sample, (d) defining a transformation from the detected landmark position, (e) obtaining a referenced light-emission image by applying the transformation onto the light-emission image.

### FIELD OF THE INVENTION

The instant invention relates to methods and installations for obtaining an image of a sample emitting a light signal from within its inside.

### BACKGROUND OF THE INVENTION

In the field of pharmaceutical imaging, detection of light emitted from inside an animal (often a mammal) has become an effective way of qualifying the occurrence of a phenomenon under study taking place inside the animal.

It is an object of the present invention to provide an improved system and method by which the detected light signal can be accurately associated with a region of the animal from which it is emitted.

### SUMMARY OF THE INVENTION

To this aim, it is provided a method for obtaining an image of a sample having an external surface enclosing an inside, a light signal being emitted from within said inside, the method comprising:

(a) providing, at least two positioning images each comprising detection data related to the external surface of the sample,

(b) providing, for at least one time of an observation period, a light-emission image of the sample comprising data related to the light signal emitted from within said inside of the sample,

(c) on each of said positioning images, detecting, an external contour of said sample and a landmark pattern integral with the sample,

(d) defining a transformation to be applied to the light-emission image from the detected landmark position,

(e) obtaining a referenced light-emission image by applying said transformation onto said light-emission image.

By the use of landmarks integral with the animal, it becomes easier to associate the detected light signal with the part of the animal from which it is emitted.

According to another aspect, the invention relates to a corresponding imaging installation and software.

In some embodiments, one might also use one or more of the features as defined in the dependant claims.

### BRIEF DESCRIPTION OF THE DRAWINGS

Other characteristics and advantages of the invention appear from the following description of three of embodiments thereof given by way of non-limiting example, and with reference to the accompanying drawings.

In the drawings:

FIG. 1 is a diagrammatic perspective view of a marking device;

FIG. 2 is a diagrammatic perspective view of an imaging apparatus;

FIG. 3 is a diagrammatic plane view of the inside of the enclosure of a first embodiment of the apparatus of FIG. 2;

FIG. 4 is a block diagram of an example of processing the data;

FIG. 5 is a diagram showing an example of the processing performed by the processor unit of FIG. 4;

FIG. 6 is a schematic top view of a marked sample;

FIG. 7 is a plan view showing, on the left side, the extracted marks at two successive times and, on the right side, the extracted marks after applying the displacement field to the marks corresponding to one of the times;

FIG. 8 is an exemplary view of a calculated displacement field;

FIG. 9 is a top view of a positioning image superimposed to a light-emission image;

FIG. 10 is a view corresponding to FIG. 3 for a second embodiment of the invention;

FIG. 11 is a view corresponding to the positioning images obtained with the installation of FIG. 10; and

FIG. 12 is a view corresponding to FIG. 3 for a third embodiment of the invention.

### DETAILED DESCRIPTION OF THE INVENTION

In the various figures, like references designate elements that are identical or similar.

FIG. 1 is an exemplary perspective view showing a marking device 100 suitable for marking an animal 2 with a suitable number of landmarks M₁, M₂, . . . , Mₙ.

The marking device 100 is for example an electronically controlled printing device comprising a support 101 adapted to receive the animal 2, for example previously anesthetized. A module 102 comprising a printing head 103 and an imaging camera 104 is carried at the end of an arm 105 movable with respect to the support 101 along two displacement axis X, Y in a plane parallel to the support above the animal 2. The printing head is in a fluid communication with an ink tank 106 providing ink to the printing head. A computerized control unit 107 controls the displacement of the arm 105 in the X-Y plane and the emission of an ink drop in suitable locations of the animal 2. Suitable locations are for example determined by an user having on a display screen the output of the imaging camera 104, and determining the locations of the ink drops.

Of course, the landmarks could be of any suitable shape, such as regularly spaced dots, lines, or any other suitable patterns. Further, the arm 105 could be made to move vertically out of the X-Y plane, for example keeping constant the printing head to animal distance.

Further, it should be noted that other embodiments of marking devices are possible, provided the formed marks are made integral with the sample, i.e. will move with the sample when the sample moves.

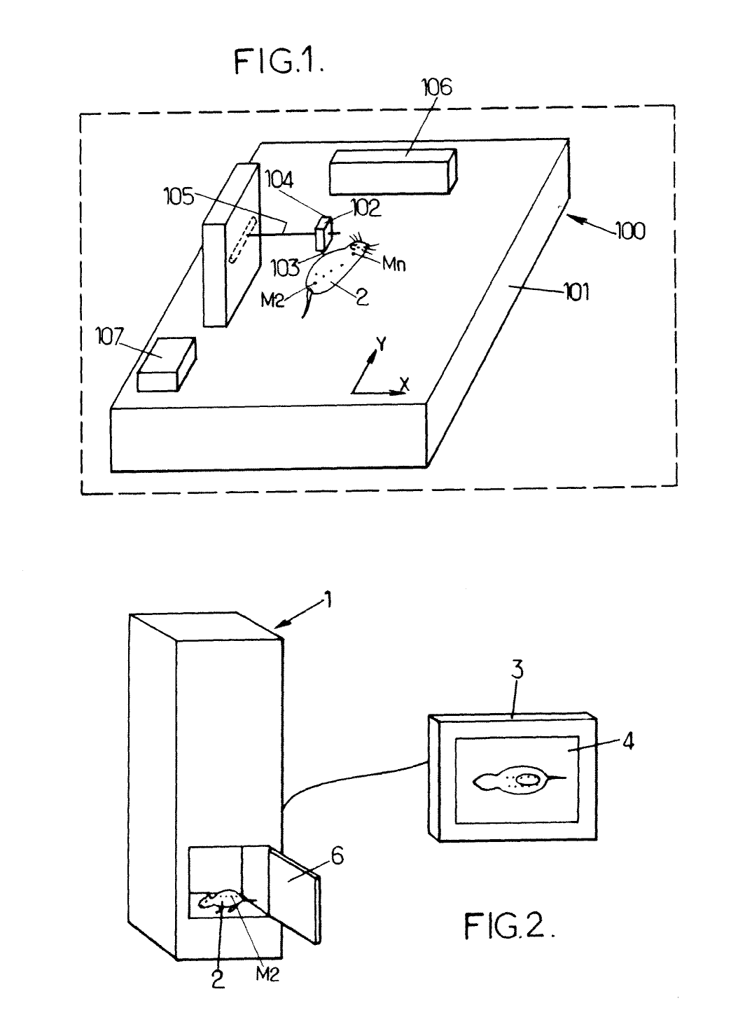

FIG. 2 diagrammatically shows an imaging apparatus 1 designed to take an image of a sample 2, and a viewing screen 3 comprising a display 4 showing an image of the sample 2.

The imaging apparatus described herein is a luminescence imaging apparatus, e.g. bioluminescence imaging apparatus, i.e. designed to take an image of a sample 2, such as, in particular, a small laboratory animal, e.g. a mammal, emitting light from inside its body. By light, It is understood an electro magnetic radiation having a wavelength between 300 nm and 1300 nm, and preferably between 400 and 900 nm.

For example, said light is generated due to a chemical reaction inside the body of the small animal. In order to obtain the chemical reaction, it is possible, for example, to use a small laboratory animal that has been genetically modified to include a gene encoding for a protein that presents the particularity of emitting light, the gene being expressed under the control of a suitable promoter upon an event.

Before placing the laboratory animal 2 in the imaging apparatus 1, or even before placing it in the marking device, the event is generated. The quantity of light given off locally is representative of the quantity of produced protein, and thus makes it possible to locally measure the level of expression of the gene.

In particular, if it is desired to check whether the gene in question is expressed particularly in response to a given event, it is possible to implement the measurement explained above firstly for a small laboratory animal 2 for which the event has been triggered, and secondly for a small laboratory animal 2 for which the event has not been triggered, in order to compare the signals emitted by the two animals.

Alternatively, the experiment in question can, for example, consist in measuring the muscular activity generated by an event in a laboratory animal, by detecting the quantity of light emitted by the coelenterazine-aequorin substrate-photoprotein pair which reacts with a given complementary chemical entity. For example, the entity in question is calcium arriving in the proximity of the photoprotein at the axons.

Since such events have a very fast time signature, it is useful to obtain information relating to the reaction rate rapidly.

According to a possible embodiment, the present method is used when imaging a moving animal. A moving animal can be either awake and running in the imaging apparatus, or still (for example anesthetized). In this latter case, the animal's movement is mainly due to breath.

The apparatus described herein can also be used to implement a method of performing imaging by delayed luminescence or phosphorescence. During such a method, a molecule adapted to emit light by phosphorescence for a time that is sufficiently long, of the order of a few minutes, is illuminated ex-vivo in order to trigger said phosphorescence. The molecule is then introduced into a small laboratory animal and can be used as a light tracer. The concentration of the molecule in a location of the organism, e.g. because a certain reaction takes place at that location, and because the molecule in question participates in said reaction, is detectable by the apparatus described below and makes it possible to characterize the reaction in question quantitatively or qualitatively.

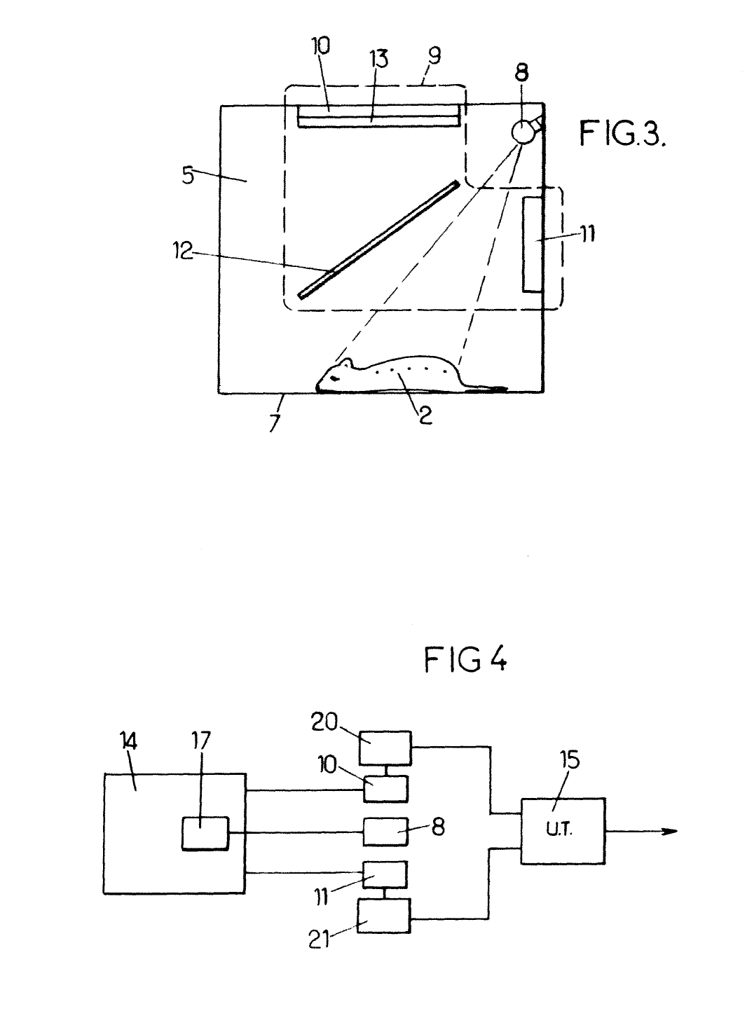

As shown in FIGS. 2 and 3, the small laboratory animal 2 is placed in an enclosure 5 that is made light-tight, e.g. by closing a door 6 or the like. As shown in FIG. 3, the enclosure has a stage 7 which, for example, is formed by the floor of the enclosure, and on which the small laboratory animal 2 is disposed, and a light source 8 generating incident illumination towards the stage 7 (e.g. conveyed by an optical fiber).

Due to the above-described reaction, the small laboratory animal 2 naturally emits a first light signal that carries information relating to the luminescence of the small animal. In addition, due to the illumination generated by the light source 8, a second positioning light signal, corresponding substantially to the incident illumination 8 being reflected by the small laboratory animal 2 is also emitted in the enclosure 5. Said second light signal can also include a portion corresponding to the autofluorescence of the sample 2 due to the illumination by the light source 8.

Said first and second light signals combine to form a combined light signal arriving at the detecting device 9 shown outlined in dashed lines in FIG. 2.

In the first embodiment shown with reference to FIG. 3, the detecting device comprises a first detector suitable for detecting a light-emission image coming from inside the sample 2 and which present a luminescence spectrum. Such a first detector 10 is, for example, a cooled charge-coupled device (CCD) camera presenting a matrix of pixels disposed in rows and in columns, an intensified CCD (ICCD), an electron multiplying CCD (EMCCD, i.e. a CCD with internal multiplication) or the like. The detecting device 9 further comprises a second detector 11 which, for example, is a conventional or an intensified CCD camera, presenting a large number of pixels disposed in rows and in columns, suitable for detecting a positioning image of the sample. In the example shown in FIG. 2, each of the first and second detectors 10, 11 is disposed on a distinct face of the enclosure 5.

In the example shown, the light source 8 emits incident illumination continuously towards the stage so that the combined light signal corresponds to a spectral combination of the first light signal (carrying the luminescence information) and of the second light signal. The combined light signal is separated by a separator plate 12, which separates the signals on the basis of their wavelengths. For example, such a separator plate is a dichroic mirror or a mirror of the “hot mirror” type that separates visible from infrared. The light signal carrying the luminescence information is transmitted substantially in full towards the first detector 10, whereas the second light signal is transmitted substantially in full to the second detector 11.

In order to be sure that only the signal carrying the luminescence information reaches the first detector 10, it is also possible to dispose a filter 13 at the inlet of the first detector 10, which filter is adapted to prevent the wavelengths that do not correspond to that signal from reaching the first detector 10.

In practice, in order to be certain that the signal reaching the first detector 10 corresponds only to the luminescence from the inside of the sample 2, provision is made for the autofluorescence signal emitted by the sample under the effect of the light source 8 to present a wavelength that is different from the wavelength of the signal in question. To this end, it is possible to choose to work with a light source 8 that emits incident illumination presenting an adapted spectrum, distributed beyond the range of wavelengths emitted by luminescence. For example, it is possible to use infrared illumination centered on a wavelength substantially equal to 800 nanometers (nm) when the luminescence spectrum presents a longest wavelength of 700 nm or shorter.

Other variations are possible, where the illumination is synchronized with the acquisition of the light-emission images by periodically shuttering the light-emission detecting camera.

As shown in FIG. 4, an electronic control unit 14 is disposed that defines a plurality of time frames of an observation period, each of which lasts a few milliseconds, corresponding substantially to the time necessary to acquire and to store a cinematographic representation of the stage 7 by means of the second detector 11. This cinematographic representation comprises a plurality of data pairs comprising co-ordinates and a light property (brightness, etc.). It is possible to set said time frames to have a time determined by the user, if said user desires a given acquisition rate, e.g. such as 24 images per second, or some other rate. At the start of each time frame, the preceding signal generated in the second detector 11 is read and stored in a second memory 21, as are the co-ordinates relating to each pixel, and another acquisition starts at the second detector 11.

In similar manner, at the start of each time frame, the signal generated by the first detector 10 is stored in a first memory 20 as are the co-ordinates relating to each pixel. A processor unit 15 is adapted to read the data stored in the first and second memories 20, 21, so as store it and/or so as to display the corresponding images on the display 4.

However, it can happen that it is preferable not to read the data measured at the first detector 10 for each time frame, but rather once every n time frames, where n is greater than 1, in order to allow the light-emission signal to accumulate to improve the signal-to-noise ratio.

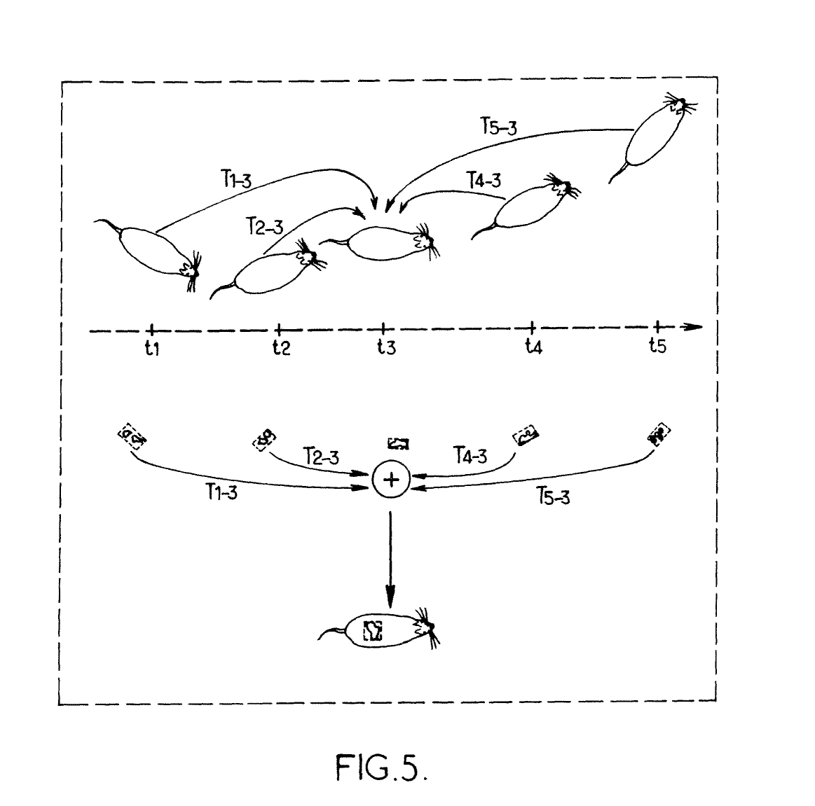

FIG. 5 shows, at the top, five positioning images of the sample 2 that are acquired successively by the second detector 11 at successive times t₁, t₂, t₃, t₄ and t₅, for example spaced from each other by a fraction of a second such as 40 ms. As is shown in FIG. 4, the sample 2 might move in various unpredictable ways from instant t₁ to instant t₅.

FIG. 5, shows, in the middle, five corresponding images carrying light-emission information from inside the sample and obtained by the first detector 10.

Once the five images coming from the second detector 11 for the five instants t₁, t₂, t₃, t₄ and t₅, and the five images coming from the first detector 10 for these instants have all been recorded, the processor unit 15 can, on the basis of the five photographic positioning representations delivered by the second detector 11, express, in a frame of reference attached to the sample at a reference time, the light-emission representations from inside the sample. For example, t₃ is set as the reference time and the displacement field T₁₋₃ to which the sample 2 has been subjected between t₁ and t₃ is extracted from the photographic representations delivered by the second detector 11, for t₁ and t₃. Then, this field of deformation T₁₋₃ is applied to the light-emission image obtained from the first detector 10 for time t₁, said processing providing, from the light-emission image of t₁, a light-emission image for t₁ expressed in the sample frame of reference at t₃. It should be mentioned that T₁₋₃ could be expressed as T₂₋₃ O T₁₋₂, where T₂₋₃ is the field of displacement to which the sample has been subjected between t₂ and t₃ and where T₁₋₂ is the field of displacement to which the sample has been subjected between t₁ and t₂.

A similar processing is performed for the images obtained at t₂, t₄ and t₅, whereby the fields of displacement T₂₋₃, T₄₋₃ and T₅₋₃ are determined. By applying these fields of displacement to the respective detected light-emission representations at t₂, t₄ and t₅, one obtains five light-emission images, each expressed in the sample frame of reference at t₃. These five images are summed as shown on the bottom of FIG. 5, so that a light emission image with a better signal-to-noise ratio is obtained for t₃. The later can be superimposed to the positioning image for t₃, as shown on the bottom of FIG. 5.

Then, a similar process can be performed at t₄ taking into account images from t₂, t₃, t₄, t₅, and t₆ (not shown, detected after t₅). Fields of displacement T₂₋₄, T₃₋₄, T₅₋₄ and T₆₋₄ are used. T₂₋₄ is expressed as T₃₋₄ O T₂₋₃ and T₆₋₄ as T₅₋₄ O T₆₋₅. Among these, T₂₋₃, T₃₋₄ and T₅₋₄ are known from the previous calculation and need not be re-calculated. In particular T₃₋₄=T₄₋₃⁻¹.

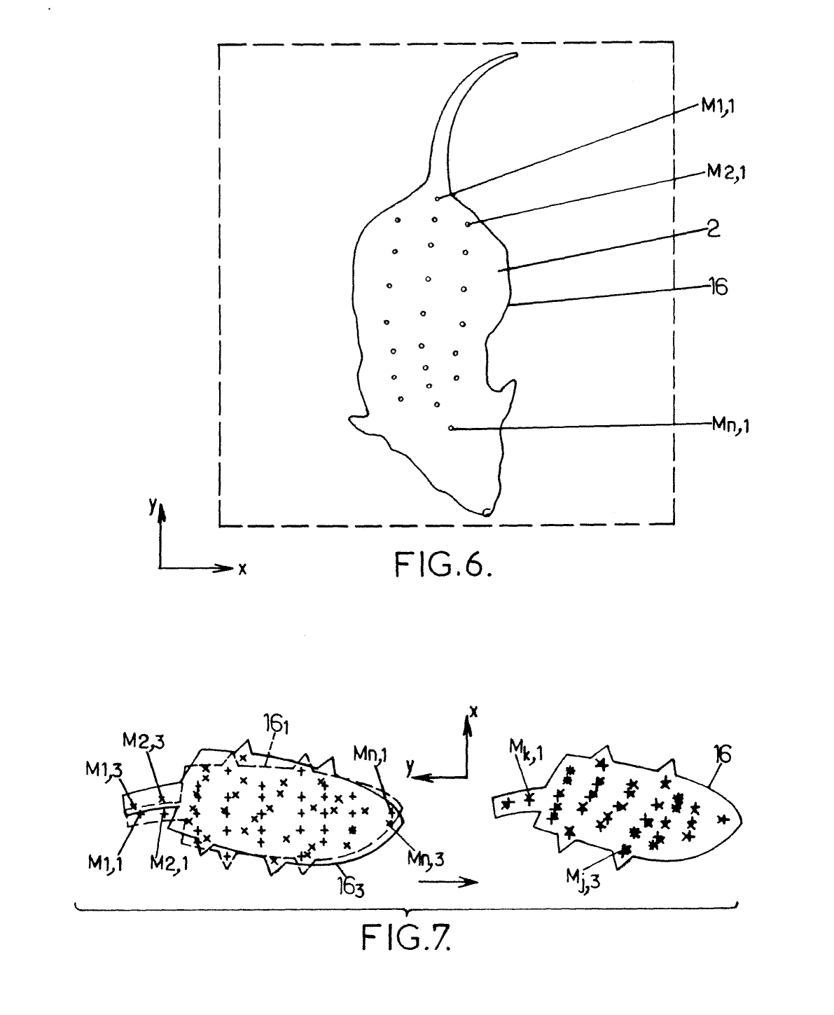

FIG. 6 shows a detailed image obtained of the animal 2 at t₁ from the positioning image detector. Image processing is performed on this image in order to extract the contour, or outline 16, of the animal, as well as the image, at time t₁ of the landmarks, M₁, M₂, . . . , Mₙ, identified on FIG. 6 as M_{1,1}, M_{2,2}, . . . , M_{n,1}. A suitable image processing method consists first in applying a threshold to the positioning representation in order to detect the outline. If the threshold provides false outline portions (most often inside the detected external real outline), these are removed either manually or automatically. The landmarks can be extracted from a pre-memorized pattern which is swept on the positioning representation for shape recognition. Wrong matches can be removed manually, or using a previously stored positioning image, for example such as the one provided from the camera 104 of the marking device 100.

Hence, the geographical location of the landmarks, in the x-y frame of reference of the detector 11, is memorized in the memory of the computerized unit for the time t₁.

The same image treatment is performed for the image obtained for the sample at time t₃, so that the geographical locations in the x-y frame of reference, of the landmarks at time t₃ M_{1,3}, M_{2,3}, . . . , M_{n,3} also stored in this memory.

It should be noted that all the detected landmarks are, in these images, enclosed by the external contour of the animal for each time.

First of all, a rigid transformation between t₁ and t₃ is estimated. This rigid transformation would be roughly estimated from the displacement of the barycentre of the detected outlines between t₁ and t₃.

The obtained geographical locations M_{1,1}, M_{2,1}, . . . , M_{n,1} at time t₁ are represented by crosses on the left side of FIG. 7. The geographical locations M_{1,3}, M_{2,3}, . . . , M_{n,3} at time t₃ are shown by plus signs on the left of FIG. 7. The respective contours are designated by 16₁ and 16₃.

A field of displacement T₁₋₃ suitable for making the contour and/or points obtained for t₁ and the contour and/or points obtained for t3 coincide is calculated.

For example, the field of displacement to be calculated is composed of a rigid displacement (global rotation), and of a global deformation which can for example be expressed by the combination of a plurality of Eigen deformation modes. An example of a method for determining the field of deformation comprises for example defining a similarity criterion between the image at t₃ and a virtual image based on the image at t₁ to which a candidate transformation has been applied. When a predefined threshold is reached, the parameters of the actual candidate transformation are memorized.

For example, the similarity criterion (or energy) is made up of a similarity criterion on the outlines (for example based on the distance maps of the shape) and on a similarity criterion on the landmarks (for example using a closest neighbour algorithm). An optical flow representing the grey level on the images can be added up into the energy criterion. The parameters of the transformation which minimize the energy criterion are determined, for example by a gradient descent method. The transformation can be parameterized in any known way such as a linear matrix, a thin plate spline model, a free-form deformation function or the like.

On the right side of FIG. 7, the points M_{K,1} obtained for time t₁ upon which the field of deformation T₁₋₃ has been applied are represented superimposed with the points M_{J,3} obtained for time t₃. The outlines globally coincide, as shown by reference 16. An example of the field of displacement T₁₋₃ calculated between time t₁ and t₃ is shown on FIG. 8. A field of displacement applied to points located in between landmarks M_{I,1}, M_{J,1}, can for example be calculated by interpolation.

The calculated field of deformation T₁₋₃ is applied onto the light emission image obtained for time t₁ in order to obtain a light-emission image corresponding to light emitted during t₁, expressed in the frame of reference of the sample at time t₃ (so-called “referenced light-emission image”).

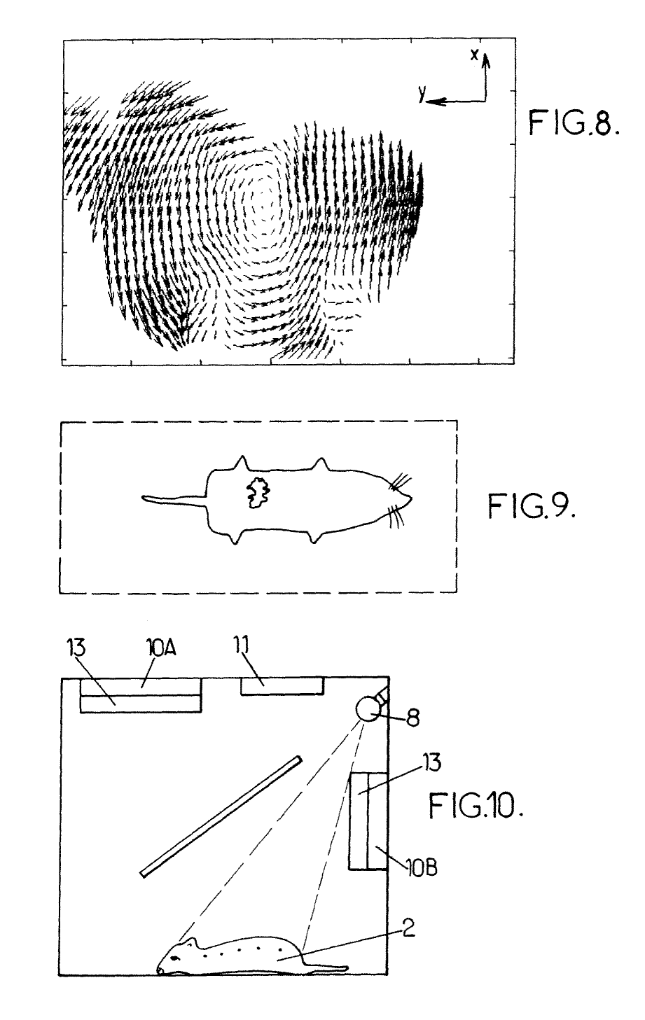

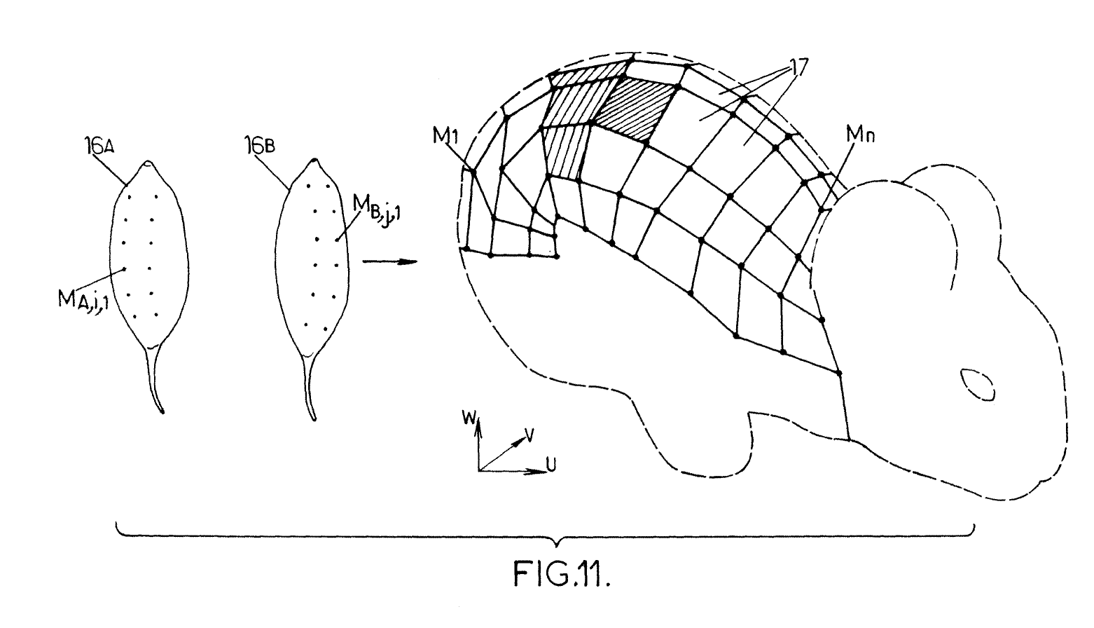

The process of FIGS. 6, 7 and 8 is also performed for the images obtained for time t₂, t₄ and t₅, so that one obtains in the frame of reference of the sample at time t₃ five referenced light-emission images which can be summed and superimposed to the positioning image for t₃, as shown on FIG. 9.

FIG. 9 is thus representative of the luminescence signal emitted between t₁ and t₅, expressed in the frame of reference of the sample at time t₃, which is in the middle of the t₁-t₅ time window. The process can of course be repeated for further reference times set as t₄, t₅, etc by taking into account luminescence detection signal from the preceding and the following times. Of course, it is not necessary to extract the contouring data from the positioning image for t₃ if this has already been done before. It is sufficient to obtain the landmarks positioning data from the memory of the computerized unit.

In the above example, the sampling times of the light emission images and of the positioning images was the same. However, in other embodiments, it is contemplated that one does not necessarily have a light emission image for each positioning image and/or that the positioning and light/emission images are not necessarily exactly simultaneous. For example, the light emission images could be each spaced in between two positioning images. Suitable interpolations of the calculated field of displacement can then be used in order to obtain a result similar to the one described above.

Further, the time of reference at which the referenced light emission image is expressed does not necessarily correspond to a time at which a positioning image is detected. For example, the invention could be implemented from four imaging times of an observation period, or any other suitable number of times of an observation period.

In a second embodiment, as shown on FIG. 10, the positioning image detecting device comprises two cameras 10A, 10B, adapted to take images of the sample along different fields of views (lines of sight). If necessary, each is provided with a filter 13, as described above.

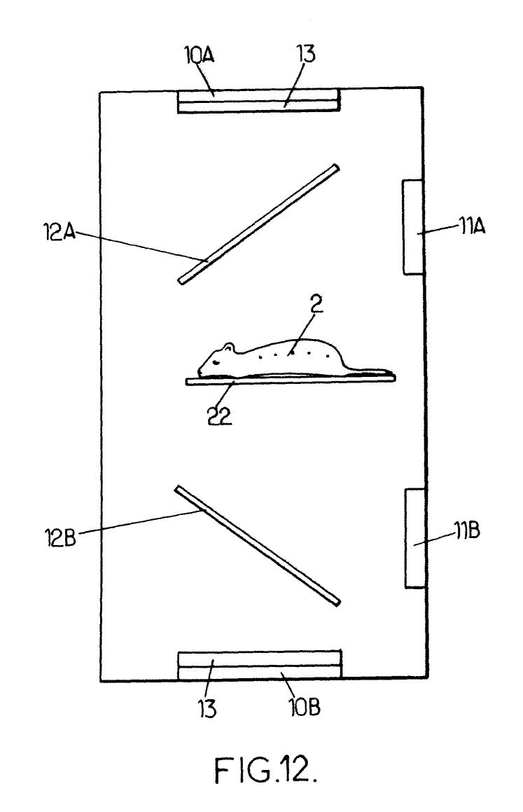

As shown on FIG. 11, the output from both cameras 10A and 10B is shown on the left of FIG. 11, for a given time t1.

As explained above in relation to FIG. 6, the contours 16a, 16b are extracted for each image from both positioning cameras. Further, the points M_{A,i,1}, and M_{B,j,1} are extracted respectively on positioning images from the respective cameras 10A, 10B in a way similar to that described in relation to FIG. 6.

The three-dimensional position, in the frame of reference U, V, W of the enclosure for each of the points Mi of the animal's surface at time t1 is calculated from the detected bi-dimensional position on both images obtained respectively from both detectors. Knowing the geographical positions of the cameras in the enclosure, the three-dimensional coordinates of the points can be stereoscopically determined from the offset, between the two images, of the points on the two images, such as applying one of the methods described in “Structure from stereo—a review”, Dhond and al., IEEE Transactions on Systems, Man and Cybernetics, November/December 1989, Volume 19, Issue 6, pp 1489-1510. This calculation enables to roughly obtain the three-dimensional outer surface of the animal as shown on FIG. 11. The three-dimensional position of the point Mi of the surface of the animal at t1 is calculated from the two-dimensional positions of the points M_{A,i,1} and M_{B,i,1}, on the respective images.

If the 3D surface of the animal is projected into a plane, the field of displacement between the image obtained by the camera 10A and the projected 3D image can be calculated as described above. This field of displacement can then be applied to the light-emission image (for example obtained along the same line of sight as the one of the camera 10A) in order to express the light emission image in an undistorted frame of reference. Further, the light emission signal as calculated according to the first embodiment and as shown on FIG. 9 is projected onto the external surface as shown on FIG. 11. For each surface element 17, the density of light emission emitted from each surface element 17 is displayed by a suitable grey level or colour on the display 4, and is represented on FIG. 11 by a more or less densely hatched element. For a pixel of the luminescence detector having an area AD, the area of the animal's outer surface corresponding to the pixel is A0, due to the outer surface inclination. Thus the measured output at this pixel is corrected to take into account this difference

The resulting three-dimensional surfacic representation of the animal and three-dimensional surfacic light-emission image can be displayed superimposed.

The above-mentioned stereoscopy calculation could be performed for each time of the observation period, or for one time only, for example if one does not wish to take into account the displacement of the animal during the imaging period.

It should be noted that the field of deformation for one of the cameras between a first time and a reference time of the observation period could be calculated as described above with relation to FIGS. 6-8, and applied to the corresponding 2D light-emission image obtained for the first time in order to obtain a 2D referenced light-emission image for the time of reference. In parallel, the 3D surfacic image of the sample can be calculated for the reference time, and the summed 2D referenced light emission image is projected onto this 3D surfacic image as described above. The summation can be made in 2D or 3D.

In another variation, it should be noted that a three-dimensional field of displacement as obtained by relation to FIGS. 6, 7 and 8 could also be determined, in the second embodiment, directly from the three-dimensional surfaces reconstructed for a first time and a reference time of the observation period. This 3D deformation can then be applied on a surface 3D light emission image for the first time in view of obtaining a referenced 3D surfacic light-emission image at the reference time. The summation is made in 3D.

It should be mentioned that more than 2 positioning cameras could be used with different angles of sight, in order to obtain the 3D surface positioning representation of the mammal.

As shown on FIG. 12, in a third embodiment, the imaging installation could comprise, when compared with the first embodiment, a second positioning camera 10B with a suitable filter, for example similar to the positioning camera 10A and a second light-emission camera 11B, for example similar to the light-emission camera 11 of the first embodiment (which is now referred to by reference 11A). The sample rests on a transparent support 22, and the second positioning camera 10B, the second light-emission camera 11B, and the second mirror 12B are disposed symmetric to the cameras 10A and 11A and mirror 12A with respect to the support 22. This embodiment will enable to detect both positioning and light-emission images along different line of sights, and to perform the above-described methods in any order and/or combination deemed suitable. The arrangement of FIG. 12 is illustrative only.

1. A method for obtaining an image of a sample having an external surface enclosing an inside, a light signal being emitted from within said inside, the method comprising:
a) providing at least two positioning images each comprising detection data related to the external surface of the sample,
b) providing, for at least one time of an observation period, a light-emission image of the sample comprising data related to the light signal emitted from within said inside of the sample,
c) on each of said positioning images, detecting, an external contour of said sample and a landmark pattern integral with the sample,
d) defining a transformation to be applied to the light-emission image from the detected landmark positions, and
e) obtaining a referenced light-emission image by applying said transformation onto said light-emission image.

2. A method according to claim 1, wherein at step a), the positioning images are obtained for respective successive times of the observation period,
wherein at step d), a field of displacement of the sample is determined from the positioning images between at least a first of said times and a reference time, and
wherein at step e), light signal emitted during said one time and expressed in a frame of reference integral with the sample at the reference time, is obtained from said field of displacement and from the light-emission image provided for said one time.

3. A method according to claim 2 wherein the referenced light-emission image is obtained by applying said field of displacement to the light-emission image provided for said first time.

4. A method according to claim 2 wherein, for each of a plurality of successive times of the observation period, a positioning image and a light-emission image are provided.

5. A method according to claim 2 comprising performing steps c) to e) for a plurality of times of the observation period, and further comprising:
f) summing the referenced light-emission images obtained at step e) from the light-emission images provided for said plurality of times.

6. A method according to claim 5 wherein said reference time is chronologically within said plurality of times.

7. A method according to claim 5 wherein steps c) to f) are repeated for a plurality of reference times.

8. A method according to claim 1 further comprising:
g) displaying superimposed a positioning image and a referenced light-emission image.

9. A method according to claim 1 wherein determining the transformation comprises:
d1) determining the position of at least one landmark on a first positioning image,
d2) determining the position of said at least one landmark on a second positioning image, and
d3) calculating a field of displacement to be applied to said landmark detected on both positioning images to be brought into coincidence with one another.

10. A method according to claim 9 wherein both positioning images are detected for successive times of an observation period, and wherein the field of displacement is related to the movement of the animal between said times.

11. A method according to claim 9 wherein both positioning images are detected along different lines of sight, and wherein the field of displacement is calculated to bring the landmarks in coincidence in three-dimensions.

12. A method according to claim 11 wherein said positioning images are taken simultaneously.

13. A method according to any preceding claim 1 wherein the obtaining step d) comprises obtaining a three-dimensional external surface of the sample from stereoscopically calculating a three-dimensional position of the landmark.

14. A method according to claim 13 wherein step e) further comprises projecting the light-emission image onto said external surface.

15. A method according to claim 1 further comprising, before providing the images,
y) detecting the positioning images, and
z) for at least one of a plurality of successive times of the observation period, detecting the light-emission image.

16. A method according to claim 1 further comprising, before providing the images,
x) marking the sample with a landmark pattern comprising at least one landmark integral with the external surface of the sample.

17. A method according to claim 16 comprising printing the landmarks on the sample.

18. A method according to claim 1 further comprising, before providing the light-emission image,
v) causing the sample to emit a light signal from within its inside.

19. A method according to claim 1 wherein the defining step d) comprises defining the transformation from the detected landmark position and the detected contour.

20. A computer software product carrying a computer software adapted to implement at least steps c) to e) of a method according to claim 1 when executed on a computer comprising:
at least two positioning images comprising detection data related to the external surface of the sample, and
a light-emission image of the sample comprising data related to the light signal emitted from within the inside of the sample.

21. An imaging installation for obtaining an image of a sample having an external surface enclosing an inside, a light signal being emitted from within said inside, the installation comprising:
a detection device adapted to provide at least two positioning images each comprising detection data related to the external surface of the sample,
said detection device being further adapted to provide, for at least one time of an observation period, a light-emission image of the sample comprising data related to the light signal emitted from within said inside of the sample,
a computerized unit adapted to detect, on each of said positioning images, an external contour of said sample and a landmark pattern integral with the sample,
said computerized unit being further adapted to define a transformation to be applied to the light-emission image from the detected landmark position,
said computerized unit being further adapted to obtain a referenced light-emission image by applying said transformation onto said light-emission image.

22. An imaging installation according to claim 21 wherein the computerized unit is adapted to define, as said transformation, a projection onto a three-dimensional surface to be applied to the light-emission image.

23. An imaging installation according to claim 22 wherein the computerized unit is adapted to determine a three-dimensional external surface of the sample from the landmark patterns detected along different lines of sight.

24. An imaging installation according to claim 22 wherein the computerized unit is adapted to define, as said transformation, a field of displacement corresponding to the movement of the landmark pattern between two successive times at which the positioning images are detected.

25. An imaging installation according to claim 21 further comprising a light-tight imaging box in which the moving sample is enclosed during the observation period.

26. An imaging installation according to claim 21 further comprising a marking device adapted to generate on the external surface of said sample at least one landmark integral with said sample.

27. An imaging installation according to claim 21 wherein said detecting device comprises a first camera adapted to detect a positioning signal emitted by the external surface of the sample, and a sensitive photo-detector adapted to detect a light signal emitted from within the inside of the sample.

28. An imaging installation according to claim 27, wherein the first camera is adapted to detect a positioning signal emitted by the sample along a first line of sight and wherein the detecting device further comprises a second camera adapted to detect a positioning signal emitted by the sample along a second line of sight.

29. A method according to claim 3 wherein, for each of a plurality of successive times of the observation period, a positioning image and a light-emission image are provided.

30. A method according to claim 3 comprising performing steps c) to e) for a plurality of times of the observation period, and further comprising:
f) summing the referenced light-emission images obtained at step e) from the light-emission images provided for said plurality of times.

31. A method according to claim 30 wherein said reference time is chronologically within said plurality of times.

32. A method according to claim 30 wherein steps c) to f) are repeated for a plurality of reference times.

33. A method according to claim 31 wherein steps c) to f) are repeated for a plurality of reference times.

34. A method according to claim 4 comprising performing steps c) to e) for a plurality of times of the observation period, and further comprising:
f) summing the referenced light-emission images obtained at step e) from the light-emission images provided for said plurality of times.

35. A method according to claim 34 wherein said reference time is chronologically within said plurality of times.

36. A method according to claim 34 wherein steps c) to f) are repeated for a plurality of reference times.

37. A method according to claim 35 wherein steps c) to f) are repeated for a plurality of reference times.

38. A method according to claim 6 wherein steps c) to f) are repeated for a plurality of reference times.
